(19) United States
(12) Patent Application Publication
(10) Pub. No.: US 2014/0087174 A1
(43) Pub. Date: Mar. 27, 2014

(54) Multilayered Foil, Sealing Material, Their Use and Production

(71) Applicant: Huhtamaki Films Germany GmbH & Co. KG, Forchheim (DE)

(72) Inventors: Matthias MAUSER, Hausen (DE); Heinz ENGELHARD, Nurnberg (DE); Michael FURST, Forchheim (DE); Peter WIELAND, Forchheim (DE)

(73) Assignee: Huhtamaki Films Germany GmbH & Co. KG, Forchheim (DE)

(21) Appl. No.: 14/032,326

(22) Filed: Sep. 20, 2013

(30) Foreign Application Priority Data
Sep. 21, 2012 (DE) 102012108938.8

(51) Int. Cl. E04B 1/66; B29C 47/06

(52) U.S. Cl. CPC E04B 1/665; B29C 47/06
USPC 428/313.3; 428/476.9; 428/327; 428/354; 264/241

(57) ABSTRACT

At least one embodiment provides a multilayered foil (100) having a first outer layer (10) and a second outer layer (30), which each comprise homo polypropylene. A central layer (20) is disposed between the first outer layer (10) and the second outer layer (30) and contains more than 25 wt % of homo polyamide and comprises copolyamide. The first outer layer (10) comprises microspheres (50).

The invention concerns a multilayered foil, a sealing material comprising such a multilayered foil, and also methods of making and using the multilayered foil and the sealing material.

Sealing materials composed of a water-impermeable material, for example bitumen, are frequently used in the building and construction trade to protect roofs from rain and other moisture. The bitumen for this can be in the form of sheeting and have a foil as surface coating. This type of foil has to meet high mechanical requirements in order to withstand the stresses of processing, which often even involves supporting the weight of a person walking thereon, as well as to protect the bitumen. In moist weather, however, these foils can frequently be fairly smooth and slippery, so they harbour a certain potential risk of accidents, especially in the case of inclined roofs. Foils which combine greater slip resistance with nonetheless very good mechanical properties are accordingly desirable for safety reasons in particular.

The problem addressed by the invention is therefore that of providing a multilayered foil having improved slip resistance and high mechanical stability. A further problem addressed is that of providing a sealing material comprising such a multilayered foil. Still further problems addressed are those of specifying methods for producing the multilayered foil and the sealing material and also uses thereof.

One of these problems at least is solved by the multilayered foil, the sealing material, the methods of production and uses according to the independent claims. Dependent claims specify advantageous embodiments.

A multilayered foil is provided. In at least one embodiment, the multilayered foil comprises:
a first outer layer, which comprises homo polypropylene;
a second outer layer, which comprises homo polypropylene; and
a central layer, which is disposed between the first outer layer and the second outer layer and which contains more than 25 wt % of homo polyamide and comprises polyamide;
   wherein the first outer layer comprises microspheres.

The first outer layer, the central layer and the second outer layer are generally disposed in sheetlike fashion, especially in coplanar fashion, on each other.

The term “on” is herein to be understood as meaning herein not only the direct, i.e. unmediated, disposition of elements, for example layers, with a common interface but also a mediated disposition where further elements can be present between the elements disposed on each other. Similarly, an element is disposed “between” a first and a second element when the element is disposed on the first element and the second element is disposed on that side of the element which is remote from the first element, where “on” is to be understood as described above.

The statement “wt %” is to be understood as meaning weight percent and is based according to this application on the entire mass of the stated layer, of the stated element/material.

A generic term used for example for a material in the context of this application, as in the case of “copolyamide” for instance, can for the purposes of this application refer to one compound or to a combination of compounds of this type. “Copolyamide” therefore represents one copolyamide or else mixtures of two or more copolyamides, for example. The same applies to other materials mutatis mutandis.

A central layer comprising polyamides acts as a barrier with regard to oil and other hydrophobic entities. This effect is described for example in DE 10 2009 057 862 A1, whose disclosure content in this regard is hereby incorporated herein by reference.

The present composition of the multilayered foil, comprising homo polypropylene in the first and second outer layers, and homo polyamide and copolyamide in the central layer, endows the multilayered foil with high mechanical stability and resistance. In a further embodiment, the multilayered foil satisfies the requirements of the ASTM 1970 standard, since it exhibits high tear strength (ASTM 4073), puncture resistance (ASTM 154) and tensile strength (ASTM 2523). The values obtained for these parameters depend on the layer thicknesses. The multilayered foil is also heat resistant, for example up to 160° C., and can thus also be laminated onto other materials.

Owing to the aforementioned properties, the multilayered foil according to the present application is useful, for example, for coating or as surface film of sealing materials which contain water-impermeable materials such as bitumen, and for sealing/covering roofs or other parts of buildings. Preferably, the multilayered foil is applied for this such that the first outer layer is disclosed on that side of the multilayered foil which is remote from the water-impermeable material.

It was found that, surprisingly, the inclusion of microspheres in the first outer layer increases the slip resistance of the multilayered foil. This effect is attributable to the microspheres enlarging the surface area of the first outer layer and is associated with an increase in static friction. The multilayered foil accordingly exhibits good grip even under moist conditions, for example in rainy weather. The increased slip resistance offers more secure footing on the multilayered foil, compared with conventional foils. Therefore, when used for coating or as surface film of sealing materials for example, the multilayered foil of the present application can reduce the risk of accidents, for example in roof works, and increase the protection of the people concerned. “Nonslip” and “anti-skid” properties for example can be used interchangeably with “slip resistance”.

Microspheres are accordingly generally useful for increasing the slip resistance if they enlarge the surface area of the first outer layer compared with such a layer without microspheres, i.e. increase the roughness of the first outer layer. The first outer layer of the multilayered foil according to the present application therefore has a surface which is blunt and not smooth. The microspheres further facilitate a form of mechanical interlocking, for example when walked on by people, as well as the enlarged surface area, i.e. an enlarged area of contact.

In a further embodiment, the microspheres have an average diameter in the range from 50 to 300 μm and especially in the range from 80 to 200 μm. The average diameter relates to the diameter of the microspheres, averaged across all spatial directions. It can be selected from the range from 100 to 180 μm, for example 120 to 150 μm. The average diameter is specified because for the purposes of the present application “microspheres” shall also be understood as meaning merely approximately sphere-shaped objects, for example ellipsoids, in the appropriate size range. In general, the microspheres will have a sphere shape, but they can also have a deformed shape to some degree, for example due to mechanical stress in processing. “Microspheres” for the purposes of the present application are accordingly shaped objects where the radii differ by less than 40%, especially by less than 25%, from the ideal radius of a sphere shape.

Microspheres of the abovementioned size would in principle be expected to greatly reduce the mechanical stability of the first outer layer and hence of the multilayered foil as a whole. The present combination of materials in the layers of the multilayered foil, i.e. homo polypropylene in the first and second outer layer and also homo polyamide and copolyamide in the central layer, compensates the structurally weakening effect of the microspheres and preserves high mechanical stability. Advantageously, therefore, the multilayered foil exhibits, as described above, not only high mechanical stability, especially high tear strength, and a very good barrier effect against oil, but also has a high slip resistance and also reduces the risk of accidents, for example in the event of moist weather. Preferably, only the first outer layer is equipped with microspheres, so the surface of the second outer layer is smooth or—owing to the microspheres in the first outer layer—minimally uneven.

The microspheres can further be incorporated in the multilayered foil in a very economical manner, for example by co-extrusion or blown co-extrusion. Advantageously, therefore, unlike conventional measures to increase slip resistance, the incorporation of microparticles does not require an additional operation. Conventionally, slip resistance is increased by applying additional layers, for example varnishes or adhesive layers, which generally needs a further, separate operation. Subsequent embossing or other mechanical roughening of a foil is similarly very uneconomical.

In a further embodiment, the first outer layer contains 0.1 to 2.0 wt %, especially 0.2 to 1.5 wt %, of microspheres. The first outer layer may preferably contain 0.3 to 0.8 wt %, for example 0.5 wt %, of microspheres.

The microsphere content in such a range delivers in particular advantageous combinations of properties with regard to mechanical resistance and high slip resistance. A higher microsphere content, by contrast, weakens the structure of the multilayered foil, while a lower content leads to a lower slip resistance.

In a further embodiment, the microspheres are solid and/or hollow, especially hollow. “Hollow” in this case is to be understood as meaning that a microsphere has a void space unfilled or incompletely filled with a solid or a liquid. A void space of this type generally contains a gas or a gas mixture including, for example, air. The void space in hollow microspheres is surrounded by a shell to form a kind of sphere. Microspheres in this embodiment can also be referred to as “microspheres”. Hollow microspheres generally each comprise a single void space and not, as in the case of porous materials, a multiplicity of cavities. The microspheres may preferably comprise a polymer, especially a thermoplastic polymer, or consist thereof to an extent of not less than 70 wt % or else completely.

In a further development of this embodiment, the microspheres have a shell which surrounds a void space and which consists of thermoplastic polymer to an extent of not less than 70 wt %, especially not less than 80 wt %, or completely. Acrylonitrile copolymers are an example of suitable polymers.

The void space in microspheres may contain hydrocarbons, for example. These microspheres can be formed from polymer spherules filled with liquid, for example hydrocarbons, in which case the liquid is chosen such that it transitions from the liquid into the gaseous state, and thus inflates the microspheres, during any processing at high temperature, for example during the production of the multilayered foil by coextrusion. In the course of the inflating step, or else thereafter, a gaseous hydrocarbon can partly or else wholly escape. For example, the diameter of a microsphere before temperature elevation can be selected from the range extending from 15 to 40 μm and be about 120 to 150 μm after temperature elevation.

Advantageously, these microspheres are of low density, especially a density lower than that of solid microspheres, so the weight/density of the multilayered foil can be reduced. Microsphere density can be less than 0.2 g/cm³, especially less than 0.1 g/cm³. Microsphere density is generally in the range from 0.02 to 0.08 g/cm³.

A further advantage is that the microspheres before temperature elevation are easy to distribute homogeneously in the material for the first outer layer, facilitating the production process and serving to form a mechanically stable multilayered foil which is uniform. There are generally no special apparatus requirements for this; the multilayered foil is obtainable by coextrusion or blown coextrusion, for example. This, if at all, is only possible to a limited extent with inorganic fillers such as sand or a granular material, since the equipment used suffers severe abrasion and corrosion as a result, which, if at all, is barely the case with the microspheres described above. In contradistinction to inorganic fillers, moreover, the microspheres become very firmly integrated into the first outer layer and hence the multilayered foil, so they can generally not be dislodged thereafter.

Hollow microspheres are also reversibly compressible. In other words, the microspheres can be squashed, for example to transport the multilayered foil or walked on, and subsequently return to their initial shape without the microspheres or the multilayered foil incurring any damage as a result of the mechanical stress. By contrast, inorganic fillers are incompressible a foil can be damaged by their corners and edges, which leads to leaks.

As a result of the hollow microspheres being “inflated” in the course of processing, the first outer layer is partly foamed up as it were. In contradistinction to the use of conventional blowing agents, for example azodicarbonamide (for example Luvopor AZ/40 G-UT), however, its integrity remains intact. When conventional blowing agents are used, a corresponding layer can suffer almost complete destruction, so even subsequent layers can occasionally become damaged. This is not the case when a multilayered foil according to the present application comprises hollow microspheres.

According to the invention, both the first outer layer and the second outer layer comprise homo polypropylene. This ensures sufficient mechanical strength and thermal stability for the multilayered foil. Preferably, the first outer layer and/or the second outer layer contain not less than 40 wt % of homo polypropylene, especially in a range from 50 to 90 wt %. The first outer layer and/or the second outer layer may contain 53 to 80 wt %, especially 55 to 70 wt %, for example 57 to 65 wt %, of homo polypropylene. It is particularly preferable for both the first outer layer and the second outer layer to have such a homo polypropylene content, although this can in each case be selected independently of each other, even from different ranges.

In a further embodiment, the first outer layer and/or the second outer layer contain 10 to 40 wt %, especially 15 to 35 wt %, of ethylene-acrylate copolymer. The first outer layer and/or the second outer layer can more particularly contain 20 to 30 wt %, for example 25 wt %, of ethylene-acrylate copolymer. The acrylate content of the ethylene-acrylate copolymer can be partly selected, at least 80 wt % selected or else wholly selected, from alkyl acrylate. The alkyl acrylate is particularly butyl acrylate, so the ethylene-acrylate copolymer is an ethylene-butyl acrylate copolymer. Preferably, not only the first outer layer but also the second outer layer have an ethylene-acrylate copolymer content selected in each case independently of each other as described above.

The proportion of ethylene-acrylate copolymer so as to improve the tear strength of the multilayered foil and, compared with a purely polypropylene outer layer, provides a comparatively blunt, rubbery surface, which contributes to slip resistance. This further improves the anchoring of the multilayered foil on a water-impermeable sealing material, for example bitumen, making the multilayered foil very useful for this purpose. In addition, the ethylene-acrylate copolymer also facilitates the forming of an overlapping adhesive bond between sealing sheets and improves the imperviousness of such a bond.

Combined with homo polypropylene, therefore, a very durable, mechanically strong and very conveniently processible multilayered foil is obtained. In a preferred embodiment, therefore, the first outer layer and the second outer layer each independently contain 55 to 80 wt % of homo polypropylene and 15 to 35 wt % of ethylene-acrylate copolymer.

As described above, very advantageous multilayered foils are obtainable via the combination of homo polypropylene with ethylene-acrylate copolymer. Therefore, the first outer layer and/or the second outer layer may contain only little, for example less than 15 wt %, especially less than 10 wt %, or even nothing by way of further polymeric compounds. The microspheres of the present application or any dyes are left out of consideration here. Polymeric compounds for the purposes of the present application have at least 500 repeat/monomeric units.

The central layer contains more than 25 wt % of homo polyamide and comprises copolyamide for a good barrier effect against oil. In a further embodiment, the central layer contains not less than 30 wt % of copolyamide. Preferably, the central layer contains 30 to 60 wt % of homo polyamide and 40 to 70 wt % of copolyamide. It can contain 35 to 50 wt %, especially 35 to 45 wt %, of homo polyamide. The central layer can further contain 50 to 65 wt %, especially 55 to 65 wt %, of copolyamide.

Homo polyamides unlike copolyamides can be described using a single repeat unit. Homo polyamides and/or copolyamides can be selected from a group comprising thermoplastic aliphatic, partly aromatic and wholly aromatic homo or co polyamides. These homo polyamides and copolyamides can be selected from diamines, for example aliphatic diamines having two to ten carbon atoms, especially hexamethylenediamine and/or isophorone-diamine, and aromatic diamines having six to ten carbon atoms, especially p-phenylenediamine, and also from dicarboxylic acids, aliphatic and aromatic dicarboxylic acids having six to fourteen carbon atoms, for example adipic acid, terephthalic acid or isoterephthalic acid, and from lactams, for example ε-caprolactam. Useful polyamides include polyamide 6, polyamide 12, polyamide 66, polyamide 61, polyamide 6T, polyamide 6/IPDI, copolymers thereof or mixtures of two or more thereof.

In a further development of this embodiment, the homo polyamide comprises a compound selected from a group comprising polyamide 6, polyamide 66 and a combination thereof. The homo polyamide can consist of these compounds, especially polyamide 6, which can be formed from ε-caprolactam, to an extent of not less than 80 wt %, or completely. The homo polyamide fraction endows the central layer with a certain hardness and stiffness, which is needed to meet the ASTM 1970 standard.

In another development of this embodiment, the copolyamide comprises a copolyamide containing isophoronediamine units. Polyamide 6/IPDI is an example of a copolyamide of this type. It can contain 1 to 10 wt %, especially 1.8 to 7 wt %, of isophoronediamine (IPD) units which are present in the IPDI together with isophthalic acid (I). The 1,3 arrangement of the functional groups in the isophoronediamine (3-aminomethyl-3,5,5-trimethylcyclohexylamine) and in isophthalic acid (1,3-benzodicarboxylic acid) result in an amorphous polyamide. Higher tear strength and toughness are obtained as a result than with polyamides with high crystallinity.

Combining these further developments results in a very advantageous central layer which endows the multilayered foil with not only high strength and hardness but also high tear strength and toughness. A central layer of this type also delivers improved thermal stability to the multilayered foil, rendering the latter long-lasting and very processible. In a further embodiment, therefore, the homo polyamide in the central layer comprises polyamide 6 while the copolyamide, for example polyamide 6/IPDI, contains isophoronediamine units. This central layer is also notable for a further improved barrier effect with regard to oil and further has gas barrier properties, especially oxygen barrier properties and/or water vapour barrier properties.

In a further embodiment, a first adhesion promoter layer is disposed between the first outer layer and the central layer and a second adhesion promoter layer is disposed between the second outer layer and the central layer. These adhesion promoter layers improve the integrity of, i.e. the adherence within, the multilayered foil, as a result of which the latter becomes more robust and has no propensity to delaminate. There may be further adhesion promoter layers, if desired. In general, however, only the first and second adhesion promoter layers are formed, so the multilayered foil is in particular a five-layered foil.

The first and second adhesion promoter layers may each independently consist of or include a material selected from a group comprising thermoplastic polymers, organic acids, organic acid anhydrides and also mixtures and compounds formed therefrom. Organic acids and acid anhydrides are more particularly selected from carboxylic acids and carboxylic anhydrides. For example, the first and/or second central layers may comprise a modified thermoplastic polymer, especially modified polyolefin homopolymer or polyolefin copolymer, for example a modified propylene homopolymer, propylene copolymer, ethylene homopolymer, ethylene-vinyl alcohol copolymer or ethylene-vinyl acetate copolymer modified with at least one organic acid or organic acid anhydride, for example maleic anhydride.

In a further development of this embodiment, the first and/or the second adhesion promoter layer comprises an ethylene-vinyl acetate copolymer modified with maleic anhydride. This can be described as a maleic anhydride-ethylene-vinyl acetate copolymer. An adhesion promoter layer may also consist thereof to an extent of not less than 70 wt %, especially not less than 80 wt %, or completely.

In addition, the first and second outer layers, the central layer and, if present, the first and second adhesion promoter layers may, if necessary, each contain additives selected independently of each other. These additives can be selected from a group comprising antioxidants, antiblocking agents, antifoggants, antistats, active antimicrobial ingredients, photo-protectants, UV absorbers, UV screens, dyes, colour pigments, stabilizing agents, especially heat stabilizers, process stabilizers and UV and/or light stabilizers, preferably based on at least one sterically hindered amine (HALS), processing aids, flame retardants, nucleating agents, crystallization agents, especially crystal nucleators, lubricants, optical brighteners, flexibilizers, sealing agents, plasticizers, silanes, spacers, fillers, peel additives, waxes, wetting agents, surface-active compounds, preferably surfactants, dispersants and combinations thereof.

The first and second outer layers, the central layer and, if present, the first and second adhesion promoter layers may each contain independently of each other 0.01 to 30 wt %, especially 0.1 to 20 wt % of one or more of the aforementioned additives. For example, the first outer layer may contain 5 to 20 wt %, especially 5 to 15 wt %, for example 10 wt %, of dyes. It is also advantageous for the purpose of protecting the multilayered foil for the first outer layer also to contain a UV stabilizer, for example in the range from 0.5 to 5 wt %, especially 1 to 3 wt %. The second outer layer may contain for example 0.5 to 5 wt %, especially 1 to 4 wt %, of an antiblocking agent.

In a further embodiment, the multilayered foil including the microspheres has an overall layer thickness of 60 to 600 μm, especially 100 to 400 μm. Overall layer thickness can be 150 to 300, especially 170 to 250, μm. These particulars include the average diameter of the microspheres, which can partially protrude from the layer. The thickness of the multilayered foil at a location without microspheres can be in the range from 10 to 300 μm, especially 20 to 200 μm, preferably 50 to 150 μm. The multilayered foil satisfies the requirements of ASTM 1970 when it has a certain minimum thickness. The thickness of the multilayered foil at a location without microspheres is preferably 100 to 200 μm and more preferably ≧125 μm. Thinner multilayered foils, for example in the range from 50 to 100 μm, can be advantageous for some particularly inexpensive uses.

The thickness of the first outer layer can be essentially predetermined by the microspheres and lie in the range from 50 to 310 μm, especially 80 to 210 μm, preferably 100 to 190 μm, for example 120 to 160 μm. The microspheres can be partially or completely enveloped by the polymer materials of the first outer layer. The thickness of the first outer layer at a location without microspheres can be about 5 to 100 μm, especially 20 to 80 μm, preferably 25 to 70 μm. The result is in effect an enlarged surface area for the first outer layer.

The thickness of the second outer layer may be about 5 to 100 μm, especially 20 to 80 μm, preferably 25 to 70 μm. The central layer can have a thickness of 5 to 100 μm, especially 7.5 to 80 μm, preferably 10 to 50 μm. The first and second adhesion promoter layers, if present, can each independently have a thickness of 1 to 30 μm, especially 2 to 20 μm, preferably 3 to 50 μm.

As described above, the mechanical stability of the multilayered foil is very good despite the microspheres. The multilayered foil in at least one embodiment according to the present application can have an ASTM E 154-10 puncture resistance of not less than 250 N, an ASTM 1970 tensile strength of not less than 110 N and/or an ASTM 4073 tear resistance (strength) of not less than 90 N.

In a further embodiment, an adhesive layer is disposed on that side of the second outer layer which is remote from the central layer. The adhesiveness of the adhesive layer can be permanent. The adhesive layer can be based on an adhesive material and can be self-adhesive at low or high temperatures, especially at low temperatures. When the multilayered foil includes at least one adhesive layer, this adhesive layer may have a removable protective foil or a removable protective layer, based on siliconized paper for example, on that side which is remote from the second outer layer. A multilayered foil of this type can be stored for a prolonged period without significant loss of adhesive properties.

The adhesive layer can be used, for example, to laminate or adhere a multilayered foil of this type on some other material, for example a water-impermeable sealing material.

A method for producing a multilayered foil is a further aspect of the present application. In one embodiment at least, at least the first outer layer, the second outer layer and the central layer disposed therebetween are produced in one step by co-extrusion to form the multilayered foil. Microspheres can be incorporated in the first outer layer and optionally inflated as described above. No additional operation is needed for this. Co-extrusion integrates the microspheres firmly in the first outer layer and hence in the multilayered foil.

Further layers disposed between the first and second outer layers, for example a first and/or a second adhesion promoter layer, can likewise be produced via co-extrusion in the same step.

Co-extrusion can take the form of blown co-extrusion in particular. This process and suitable equipment for it are known per se to a person skilled in the art. The multilayered foil of the present application is therefore preferably a blown foil, especially a five-layered blown foil.

When the multilayered foil comprises an adhesive layer and optionally also a protective layer or protective foil, these layers can be produced in at least one further step following co-extrusion.

The method can be used to obtain a multilayered foil in at least one embodiment according to the present application. The observations above therefore also hold for the method of production.

A use of a multilayered foil is a further aspect of the present application. A multilayered foil in at least one embodiment according to the present application can be used inter alia for coating, for production of sealing materials or for producing an adhesive tape, in particular for production of sealing materials.

A sealing material is accordingly a further aspect of the present application. In one embodiment at least, the sealing material comprises a water-impermeable and/or water-repellent material and a multilayered foil according to the present application disposed thereon. The water-impermeable material may more particularly comprise or consist of bitumen. Instead of or in addition to bitumen, rubber, for example butyl rubber, can be used, for example. The multilayered foil is more particularly disposed with that side which is remote from the first outer layer on the water-impermeable and/or water-repellent material of the sealing material. The multilayered foil can be disposed on the water-impermeable and/or water-repellent material via an adhesive layer or else unmediatedly, for example. The sealing material is preferably in the form of sheetings useful for sealing or covering roofs or other parts of buildings. The sealing material can be more particularly a so-called bitumen sheet or bitumen sealing sheet. The type of bitumen sheet is not restricted according to the present application. The bitumen sheets can be made self-adhesive and non-self-adhesive. Appropriate materials are known per se to a person skilled in the art. This is immaterial to any use of the multilayered foil of the present application and the advantages associated therewith.

The sealing material of the present application, for example bitumen sheets, is very readily installed, for which it is generally bonded together adhesively with an overlap to form a stable water-impermeable layer. The microspheres do not interfere with such installing, since they preferably consist (substantially) of polymers, are firmly integrated in the multilayered foil and are deformable. By contrast, conventional anti-slip coatings, which are based on a layer of varnish or adhesive or contain inorganic fillers or granules, impair the installing of sealing sheets and can lead to inferior integrity and leakages.

The multilayered foil serves to protect the water-impermeable and/or water-repellent material. The durability of bitumen in particular is increased, since the multilayered foil acts as an oil and gas barrier, so the bitumen is not aged by the loss of oil, oil-type or other apolar compounds or attacked by (atmospheric) oxygen. A loss of this type otherwise occurs particularly during the heating to install the bitumen sheets. The above-described slip resistance of the multilayered foil can for example increase the safety of people during the installation of the sealing material, for example since they are able to move around on the sealing material substantially without slipping even in the presence of moisture. After installation, the sealing material is generally covered with a further layer, for example a metal roof, shingles or roof tiles, which offer long-term protection. During this covering operation, the high slip resistance of the multilayered foil is likewise very important with regard to the safety of the people involved.

A method for producing a sealing material is a further aspect of the present application. A multilayered foil according to the present application is produced according to at least one embodiment of the above method and subsequently applied on a sealing material, for example by lamination. A sealing material as described above is obtainable thereby. The multilayered foil can be applied on the sealing material directly via the second outer layer. The microspheres present in the first outer layer occasionally also create some slight unevenness in the second outer layer, leading to improved anchoring with the sealing material due to the elevated surface.

If desired, the second outer layer may also have disposed on it an adhesive layer via which the multilayered foil can be applied. Any protective layer or foil present is first removed for this purpose.

A use of a sealing material is a further aspect of the present application. A sealing material according to at least one embodiment of the present application can be used inter alia as building material, for roof covering, for exterior cladding, for covering buildings or parts of buildings or for cladding pipes.

The invention will now be more particularly elucidated with reference to the drawings, especially by means of exemplary embodiments. Like reference signs therein refer to like, similar or identically acting elements. The figures and the size proportions of the elements depicted in the figures are not true to scale. On the contrary, the depiction of individual elements can be exaggeratedly large and/or simplified for greater ease of depiction and/or for greater ease of understanding.

In the drawings,

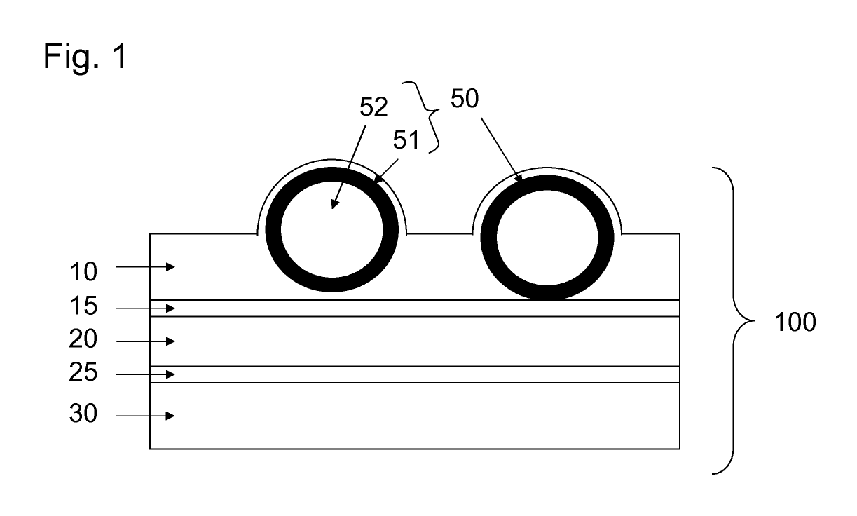

FIG. 1 shows a schematic cross section through a multilayered foil,

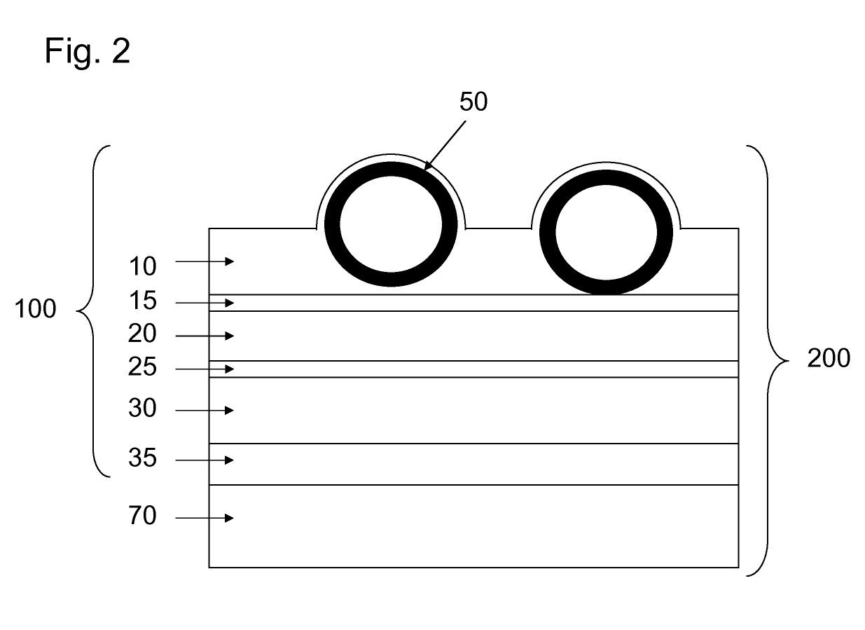

FIG. 2 shows a schematic cross section through a sealing material comprising a multilayered foil, and

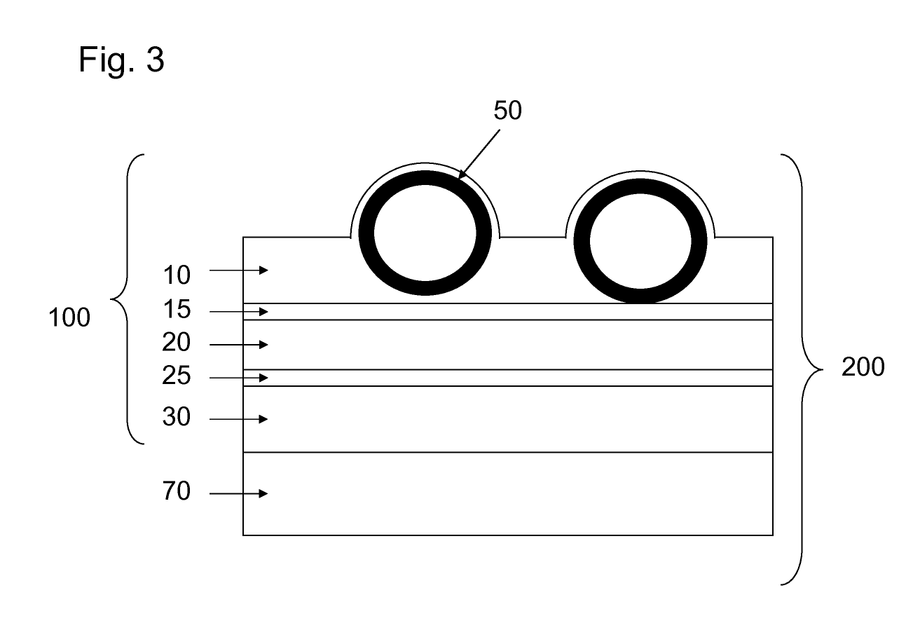

FIG. 3 shows a schematic cross section through a further embodiment of a sealing material comprising a multilayered foil.

FIG. 1 shows a schematic cross section through a multilayered foil 100 according to at least one embodiment of the present application. The multilayered foil 100 comprises a first outer layer 10, a second outer layer 30 and a central layer 20. In this example, there are a first adhesion promoter layer 15 between the central layer 20 and the first outer layer 10 and a second adhesion promoter layer 25 between the central layer 20 and the second outer layer 30. Microspheres 50 in the first outer layer 10 increase the slip resistance. The microspheres 50 are firmly integrated in the first outer layer 10 and hence in the multilayered foil 100. They can lead to unevennesses on the subsequent layers, which is not depicted here for clarity.

The multilayered foil 100 can have an overall thickness of 60 to 600 μm, especially 100 to 400 μm. The first outer layer 10 can have a layer thickness of 50 to 310 μm, especially from 80 to 210 μm, together with the microspheres 50. The microspheres 50 themselves can have an average diameter of 50 to 300 μm, especially 80 to 200 μm. They are generally enveloped by the polymer materials of the first outer layer 10. The central layer and the second outer layer 30 can have layer thicknesses of 5 to 100 μm, especially 7.5 to 80 μm, and, respectively, 5 to 100 μm, especially 20 to 80 μm. The first and second adhesion promoter layers 15, 25 each have a layer thickness of 1 to 30 μm, especially 2 to 20 μm.

The first outer layer 10 contains homo polypropylene, for example at not less than 40 wt %, and 10 to 40 wt % of ethylene-acrylate copolymer, especially ethylene-butyl acrylate copolymer. Similarly, the second outer layer 30 may comprise these materials. The central layer 20 comprises more than 25 wt % of homo polyamide, for example polyamide 6, and not less than 30 wt % of copolyamide which contains isophoronediamine units in particular, for example polyamide 6/IPDI. The two adhesion promoter layers 15, 25 contain an ethylene-vinyl acetate copolymer modified with maleic anhydride.

Microspheres 50 shown in FIG. 1 are hollow microspheres 50, or microspheres, where a shell 51 surrounds a void space 52. The shell 51 comprises thermoplastic polymers, for example an acrylonitrile copolymer. In the course of the production of the multilayered foil 100, for example by co-extrusion, the microspheres 50 may have been inflated by converting a liquid material, for example hydrocarbons, into the gaseous state.

Owing to the microparticles 50, the surface of the first outer layer 10 is elevated, so the depicted multilayered foil 100 has much improved slip resistance. Despite the microparticles 50, the multilayered foil 100 has very high mechanical stability and thermal stability, which are largely attributable to the polymer materials used for the first and second outer layers 10, 30 and for the central layer 20.

The foil shown in FIG. 1 can be for example a blown foil, for example a blown five-layered foil. On that side of the second outer layer 30 which is remote from the central layer 20, there can be an adhesive layer and optionally a protective layer or a protective foil (not shown here).

FIG. 2 shows a schematic cross section through a sealing material 200 according to at least one embodiment. The sealing material 200 comprises a multilayered foil 100 as described by way of example for FIG. 1. The multilayered foil 100 is laminated via an adhesive layer 35 on a water-impermeable or water-repellent material 70, which comprises or consists of bitumen for example. The sealing material 200 shown in FIG. 2 can for example be embodied as a sealing sheet, especially a bitumen sealing sheet, with the multilayered foil 100 as surface coating or surface film and be suitable for sealing or covering roofs or other parts of buildings.

The multilayered foil 100 therein protects the water-impermeable material 70 from harmful gases, for example atmospheric oxygen, and acts as an oil barrier, especially during the installation of the sealing material. Owing to the microspheres 50 in the first outer layer 10, the slip resistance on the surface of the multilayered foil 100 and hence of the sealing material 200 is substantially increased. This reduces the accident risk of people on a roof for the purpose of installing the sealing material 200 for example, since they are able to find firm footing even under moist conditions.

FIG. 3 shows a schematic cross section through a sealing material 200 according to at least one further embodiment. It resembles the embodiment depicted in FIG. 2. The multilayered foil 100 here is disposed directly on the water-impermeable material 70 via the second outer layer 30. Minor unevennesses in the second outer layer (not depicted here), attributable to the microspheres 50 in the first outer layer, lead to improved adhesion on the water-impermeable material 70.

### OPERATIVE EXAMPLE

The first outer layer 10 has a thickness of 37.5 μm at a location without microspheres 50 and contains 62 wt % of homo polypropylene (for example Flint Hills P4-198), 25 wt % of ethylene-butyl acrylate copolymer (for example Lucofin 1400 HN), and 0.5 wt % of hollow microspheres 50 (for example Advancel EMS-024 MB). The first outer layer further contains 0.5 wt % of a perfluorinated processing aid (for example Luvofilm 9679) incorporated in low density polyethylene (LDPE), 10 wt % of black colour pigment (for example Polyblak 1423) and 2 wt % of UV stabilizer (for example Polybatch UVS 210).

The second outer layer 30 has a thickness of 43.5 μm and contains 65 wt % of homo polypropylene (for example Flint Hills P4-198), 25 wt % of ethylene-butyl acrylate copolymer (for example Lucofin 1400 HN), 2 wt % of UV stabilizer (for example Polybatch UVS 210), 5 wt % of black colour pigment (for example Polyblak 1423) and 3 wt % of antiblocking agent (for example Multibatch MP52659).

The central layer 20 is 30 μm in thickness and contains 39.5 wt % of polyamide 6 (for example Durethan B 40 FAM), 60 wt % of polyamide 6/IPDI (for example Durethan C 38F) and 0.5 wt % of perfluorinated processing aid (for example Luvofilm 9679) incorporated in LDPE.

The first adhesion promoter layer 15 is 7 μm in thickness and contains 63 wt % of a polypropylene-acid anhydride copolymer (for example Admer QB 520E), 2 wt % of UV stabilizer (for example Polybatch UVS 210), 25 wt % of polypropylene (for example Flint Hills P4-198) and 10 wt % of black colour pigment (for example Polyblak 1423).

The second adhesion promoter layer 25 is 7 μm in thickness and contains 73 wt % of a polypropylene-acid anhydride copolymer (for example Admer QB 520 E), 2 wt % of UV stabilizer (for example Polybatch UVS 210) and 25 wt % of polypropylene (for example Flint Hills P4-198).

The overall thickness of the multilayered foil 100 is 125 μm at a location without microspheres 50. The multilayered foil was produced via blown co-extrusion.

The multilayered foil in this operative example has an ASTM E 154-10 puncture resistance of not less than 250 N, an ASTM 1970 tensile strength of not less than 110 N and also an ASTM 4073 tear resistance (strength) of not less than 90 N.

The fact that the invention is described by means of operative examples does not mean it is limited thereto. On the contrary, the invention comprises every novel feature and also every combination of features, which more particularly includes every combination of features in the claims and every combination in the operative examples, even though this feature or combination itself is not explicitly recited in the claims or operative examples.

### LIST OF REFERENCE SIGNS

10 first outer layer
15 first adhesion promoter layer
20 central layer
25 second adhesion promoter layer
30 second outer layer
35 adhesive layer
50 microsphere
51 shell
52 void space
70 water-impermeable material
100 multilayered foil
200 sealing material

1. A multilayered foil, comprising:
a first outer layer, which comprises homo polypropylene;
a second outer layer, which comprises homo polypropylene; and
a central layer, which is disposed between the first outer layer and the second outer layer and which contains more than 25 wt % of homo polyamide and comprises copolyamide;
wherein the first outer layer comprises microspheres.

2. The multilayered foil according to claim 1, wherein the microspheres have an average diameter in the range from 50 to 300 μm.

3. The multilayered foil according to claim 1, wherein the first outer layer contains 0.1% to 2.0 wt % of microspheres.

4. The multilayered foil according to claim 1, wherein the microspheres have a shell which surrounds a hollow space and which consists of thermoplastic polymer to an extent of at least 70 wt %.

5. The multilayered foil according to claim 1, wherein the first outer layer and/or the second outer layer contains at least 40 wt % homo polypropylene, especially in the range from 50 to 90 wt %.

6. The multilayered foil according to claim 1, wherein the first outer layer and/or the second outer layer contains 10 to 40 wt % ethylene-acrylate copolymer.

7. The multilayered foil according to claim 1, wherein the first outer layer and the second outer layer each independently contains 55 to 80 wt % homo polypropylene and 15 to 35 wt % ethylene-acrylate copolymer.

8. The multilayered foil according to claim 7, wherein the first outer layer and/or the second outer layer aside from homo polypropylene and ethylene-acrylate copolymer contains less than 15 wt % of further polymeric compounds.

9. The multilayered foil according to claim 1, wherein the central layer contains at least 30 wt % of copolyamide.

10. The multilayered foil according to claim 1, wherein the central layer contains 30 to 60 wt % homo polyamide and 40 to 70 wt % copolyamide.

11. The multilayered foil according to claim 1, wherein the central layer comprises polyamide 6 as homo polyamide and the copolyamide contains isophoronediamine units.

12. The multilayered foil according to claim 1, wherein a first adhesion promoter layer is disposed between the first outer layer and the central layer and a second adhesion promoter layer is disposed between the second outer layer and the central layer.

13. The multilayered foil according to claim 1, wherein an adhesive layer is disposed on that side of the second outer layer which is remote from the central layer.

14. A method for producing a multilayered foil according to claim 1, wherein at least the first outer layer, the second outer layer and the central layer disposed therebetween are produced by co-extrusion to form the multilayered foil.

15. A coating, sealing material or adhesive tape comprising a multilayered foil according to claim 1.

16. A sealing material, comprising a water-impermeable and/or water-repellent material and a multilayered foil according to claim 1 disposed thereon.

17. A building material, roof covering, exterior cladding, buildings covering or parts of buildings covering or pipe cladding, comprising the sealing material according to claim 16.
